(19) United States
(12) Patent Application Publication
(10) Pub. No.: US 2023/0055915 A1
(43) Pub. Date: Feb. 23, 2023

(54) BATTERY COOLING DEVICE FOR ELECTRIC VEHICLE AND BATTERY MODULE USING THE SAME

(71) Applicant: HYUNDAI MOBIS Co., Ltd., Seoul (KR)

(72) Inventor: Young Chan YOON, Yongin-si (KR)

(73) Assignee: HYUNDAI MOBIS Co., Ltd., Seoul (KR)

(21) Appl. No.: 17/891,301

(22) Filed: Aug. 19, 2022

(30) Foreign Application Priority Data
Aug. 20, 2021 (KR) 10-2021-0110484
Sep. 16, 2021 (KR) 10-2021-0124324
Nov. 16, 2021 (KR) 10-2021-0158008
Apr. 18, 2022 (KR) 10-2022-0047818

(51) Int. Cl. H01M 10/625; H01M 10/613; H01M 10/6556; B60L 58/26; B60L 50/64

(52) U.S. Cl. CPC H01M 10/625; H01M 10/613; H01M 10/6556; B60L 58/26; B60L 50/64; H01M 2220/20

(57) ABSTRACT

A battery cooling device for an electric vehicle includes a cooling block including accommodating units, each accommodating unit accommodating an end part of one or more battery cells. The cooling block cools lateral circumferences of the battery cells accommodated in the accommodating units. The cooling block includes an inlet nipple to introduce coolant into the cooling block, an inlet chamber to communicate with the inlet nipple, branch channels individually connected to the inlet chamber, an outlet chamber to communicate with each of the branch channels, and an outlet nipple to discharge the coolant to the outside.

### CROSS-REFERENCE TO RELATED APPLICATIONS

This application claims the benefit under 35 USC 119(a) of Korean Patent Application No. 10-2021-0110484, filed on Aug. 20, 2021, Korean Patent Application No. 10-2021-0124324, filed on Sep. 16, 2021, Korean Patent Application No. 10-2021-0158008, filed on Nov. 16, 2021, Korean Patent Application No. 10-2022-0047818, filed on Apr. 18, 2022, the entire disclosure of which is incorporated herein by reference for all purposes.

### BACKGROUND

### 1. Technical Field

The present disclosure relates to a battery cooling device for an electric vehicle and a battery module using the battery cooling device, and more particularly, to a battery cooling device for an electric vehicle and a battery module using the battery cooling device, which provide a structure of a cooling block for efficiently cooling a battery for an electric vehicle, and to which an optimal nipple position is applied for uniform distribution of coolant flowing through the cooling block.

In addition, the present disclosure relates to a battery insertion type cooling system capable of improving battery cooling efficiency by configuring a battery cooling block having a battery insertion type to increase a contact area between battery cells and the battery cooling block.

### 2. Related Art

As interest in environmental protection increases, the development of another type of vehicle that is eco-friendly and fuel-efficient, for example, a hybrid vehicle, i.e., an electric vehicle, or a fuel cell vehicle, has been actively promoted instead of a conventional vehicle using a combustion engine.

Since a hybrid or electric vehicle using a motor as a driving source requires high voltage and current, a battery module in which a plurality of battery cells are stacked adjacent to one another is used in the hybrid or electric vehicle.

When the battery module is used for a long time, heat is generated from the battery module (battery cells). If the heat generated from the battery module is not sufficiently removed (cooled), the performance of the battery module deteriorates or the risk of ignition or explosion increases. Therefore, the temperature of the battery module needs to be maintained at an appropriate temperature condition.

Recently, the charging time of a battery for an electric vehicle, which is continuously reduced, and the demand for a high-performance electric vehicle requires a higher cooling capacity of the battery for the electric vehicle.

Accordingly, conventionally, a method of contacting a cooling block, for example, a water-cooled cooling block, with the outermost end parts of battery cells and cooling the battery cells by mutual heat exchange between the cooling block and the battery cells has been proposed.

However, conventionally, as the cooling block contacts the outermost end parts of the battery cells with a very small contact area, there is a problem that it is difficult to sufficiently remove heat generated from the battery cells.

In addition, due to the characteristics of the battery cells having low thermal conductivity, when only the outermost end parts of the battery cells are cooled, there is a problem that a temperature deviation between the battery cells for each section or part increases. Therefore, there is a problem that it is difficult to effectively respond to an increase in a heat value, which is attributable to high density of the battery cells and a reduction in charging time.

Accordingly, in recent years, various studies have been made to improve the cooling performance of the battery cells and the stability and reliability of the battery cells, but the studies are still insufficient, and the development of the battery cells is further required.

Therefore, it is necessary to develop a battery cooling system that solves the above-described problems and exhibits sufficient cooling performance by designing a structure that increases the contact area between the battery cells and the cooling block.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

Various embodiments are directed to a battery cooling device for an electric vehicle, a manufacturing method thereof and a method of determining a coolant inlet/outlet diameter ratio of the battery cooling device for an electric vehicle, which propose a structure of a cooling block for efficiently cooling a battery for an electric vehicle, so that the battery temperature can be more efficiently managed as the sides of battery cells are cooled, an effect of reducing the charging time can be expected, and a diameter ratio of a nipple for uniform distribution of coolant flowing through the cooling block can be determined.

The problems to be solved by the present disclosure are not limited to the above-mentioned problems, and it will be said that the objects or effects that can be grasped from the technical solutions or embodiments described below are also included.

In one general aspect, a battery cooling device for an electric vehicle includes: a cooling block including accommodating units, each accommodating unit being configured to accommodate an end part of one or more battery cells, the cooling block being configured to cool lateral circumferences of the battery cells accommodated in the accommodating units. The cooling block includes: an inlet nipple configured to introduce coolant into the cooling block; an inlet chamber configured to communicate with the inlet nipple; branch channels individually connected to the inlet chamber; an outlet chamber configured to communicate with each of the branch channels; and an outlet nipple configured to discharge the coolant to the outside.

The cooling block may be composed of a thermally conductive material.

The branch channels may be disposed along a first direction, and the inlet and outlet nipples may be disposed along a second direction intersecting the first direction.

The accommodating units may be slots and a heat transfer interface material may be disposed on an inner surface of each of the slots, and the heat transfer interface material may be in close contact with a side surface of each of the battery cells.

The inlet nipple may include a plurality of inlet nipples, the plurality of inlet nipples may be disposed upward from a first end of the cooling block, and the cooling block may include an inlet nipple cover configured to close all of the inlet nipples except for one specific inlet nipple.

The outlet nipple may include a plurality of outlet nipples disposed at a second end of the cooling block, and the cooling block may include an outlet nipple cover configured to close all of the outlet nipples except for one specific outlet nipple.

The inlet nipple cover may be configured to be opened or closed through bolt coupling from each of the inlet nipples.

The outlet nipple cover may be configured to be opened or closed through bolt coupling from each of the outlet nipples.

In another general aspect, a method of determining a coolant inlet/outlet diameter ratio of a battery cooling device for an electric vehicle includes: preparing a plurality of cooling blocks, each of the cooling blocks including an inlet nipple and an outlet nipple having different diameters; for each cooling block, calculating a diameter of the inlet nipple, channel widths of channels formed in a plurality of flow passages, and a diameter of the outlet nipple; for each cooling block, calculating a flow rate of cooling fluid flowing through each of the plurality of flow passages, and calculating a flow rate ratio deviation for each flow passage compared to the diameter of the inlet nipple; and for each cooling block, determining the diameters of the inlet and outlet nipples based on the calculated flow rate ratio deviation for each flow passage compared to the diameter of the inlet nipple.

Preparing the plurality of cooling blocks may include preparing a cooling block in which a channel width of a flow passage of each cooling block is equal to the diameter of the inlet nipple, a cooling block in which the diameter of the inlet nipple is one-and-a-half times larger than the channel width of the flow passage of each cooling block, and a cooling block in which the diameter of the inlet nipple is two times larger than the channel width of the flow passage of each cooling block.

In another general aspect, a battery module includes: battery cells; and a cooling block including accommodating units, each accommodating unit being configured to accommodate an end part of one or more the battery cells, the cooling block being configured to cool lateral circumferences of the battery cells accommodated in the accommodating units. The cooling block includes: an inlet nipple configured to introduce coolant into the cooling block; an inlet chamber configured to communicate with the inlet nipple; branch channels individually connected to the inlet chamber; an outlet chamber configured to communicate with each of the branch channels; and an outlet nipple configured to discharge the coolant to the outside.

The branch channels may be disposed along a first direction, and the inlet and outlet nipples may be disposed along a second direction intersecting the first direction.

The inlet nipple may be spaced apart from a first side of the cooling block at a reference interval along a longitudinal direction of the inlet chamber, and the outlet nipple may be spaced apart from a second side of the cooling block, which faces the first side of the cooling block, at the reference interval.

The inlet nipple may be spaced apart from a first side of the cooling block at a first interval, and the outlet nipple may be spaced apart from a second side of the cooling block, which faces the first side of the cooling block, at a second interval different from the first interval.

The battery module may include heat exchange members interposed between the battery cells and the accommodating units and configured to mutually exchange heat with the battery cells and the cooling block.

In accordance with the embodiments of the present disclosure, an inlet nipple and an outlet nipple for uniform distribution of coolant flowing through a cooling block are configured, which makes it possible to achieve equalization of a flow rate between flow passages inside the cooling block.

Furthermore, as the sides of battery cells are cooled, the battery temperature can be more efficiently managed, and the effect of reducing the charging time can be expected.

In accordance with the embodiments of the present disclosure, the diameters of an inlet nipple and an outlet nipple for uniform distribution of coolant flowing through a cooling block double compared to the channel width of a flow passage, which makes it possible to minimize a distribution ratio deviation due to a change in a flow rate.

In accordance with the embodiments of the present disclosure, stability and reliability as well as cooling performance can be improved.

In particular, in accordance with the embodiments of the present disclosure, a contact area between battery cells and a cooling block can be secured, and cooling efficiency and performance of the battery cells can be improved.

Other features and aspects will be apparent from the following detailed description, the drawings, and the claims.

### BRIEF DESCRIPTION OF THE DRAWINGS

FIG. 1 is a diagram illustrating a conventional battery cell bottom cooling type cooling block according to a prior art.

FIG. 2 is a diagram illustrating a battery cell insertion type cooling block in accordance with a first embodiment of the present disclosure.

FIG. 3 is a diagram illustrating a battery cooling device for an electric vehicle in accordance with the first embodiment of the present disclosure.

FIG. 4 is a graph illustrating a configuration and a flow rate ratio for each channel when an inlet nipple and an outlet nipple are positioned on the sides of a cooling block.

FIG. 5 is a graph illustrating a flow rate ratio for each channel in accordance with the present disclosure.

FIG. 6 is a schematic diagram illustrating a position change of the inlet nipple for determining optimal positions of the inlet nipple and the outlet nipple positioned on the cooling block.

FIG. 7 is a graph illustrating the flow rate ratio for each channel according to the position change of the inlet nipple.

FIG. 8 is a diagram illustrating a diameter ratio compared to a channel width of the cooling block and a position range of the inlet nipple compared to a width of the cooling block.

FIG. 9 is a flowchart sequentially illustrating a process of determining a coolant inlet/outlet diameter ratio of a battery cooling device for an electric vehicle in accordance with a second embodiment of the present disclosure.

FIG. 10 is a graph illustrating a flow rate ratio for each channel according to a diameter change of an inlet nipple.

FIG. 11 is a diagram sequentially illustrating a manufacturing method of the battery cooling device for an electric vehicle in accordance with the second embodiment of the present disclosure.

FIG. 12 is a diagram illustrating a battery module in accordance with a third embodiment of the present disclosure.

FIG. 13 is an exploded perspective diagram illustrating the battery module in accordance with the third embodiment of the present disclosure.

FIG. 14 is a diagram illustrating a cooling block in the battery module in accordance with the third embodiment of the present disclosure.

FIGS. 15 and 16 are diagrams illustrating another modified example of an inlet nipple and an outlet nipple in the battery module in accordance with the third embodiment of the present disclosure.

FIG. 17 is a diagram illustrating a flow rate ratio for each branch channel of the cooling block illustrated in FIG. 16.

FIG. 18 is a diagram illustrating a flow rate ratio for each branch channel of the cooling block illustrated in FIG. 16.

### DETAILED DESCRIPTION

Since the present disclosure may be variously modified and have various embodiments, specific embodiments are illustrated in the drawings and described in detail in the detailed description. However, it should be understood that this is not intended to limit the present disclosure to the specific embodiments, and all modifications, equivalents or substitutes included in the spirit and scope of the present disclosure are included. In describing the present disclosure, when it is determined that a detailed description of the well-known art associated with the present disclosure may obscure the subject matter of the present disclosure, the detailed description will be omitted.

Terms such as first and second may be used only to describe various components, and the components should not be limited by the terms. The terms are only used to differentiate one component from other components.

Terms used in this application are used for describing exemplary embodiments, not limiting the present disclosure. As used in this specification, the terms of a singular form may include plural forms unless referred to the contrary. It should be understood that the term such as “comprise/comprising” or “have/having” used in the application specifies the presence of features, numbers, steps, actions, members, elements, and/or groups thereof described in the specification, but does not exclude the presence or addition of one or more other features, numbers, steps, actions, members, elements, and/or groups thereof. Hereafter, exemplary embodiments of the present disclosure will be described in detail with reference to the accompanying drawings.

### First Embodiment

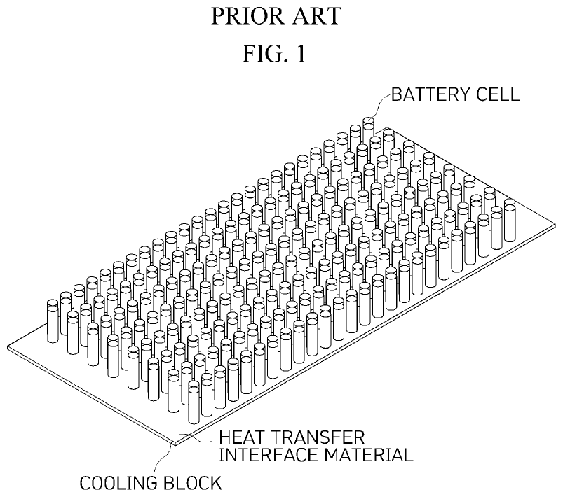

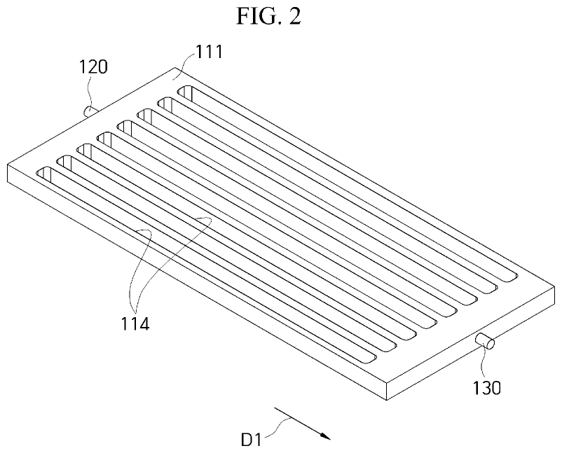

FIG. 1 is a diagram illustrating a conventional battery cell bottom cooling type cooling block according to a prior art, and FIG. 2 is a diagram illustrating a battery cell insertion type cooling block in accordance with a first embodiment of the present disclosure.

Referring to FIG. 1, the conventional battery cell bottom cooling type cooling block has a structure in which bottom or top surfaces of a plurality of battery cells are in contact with the cooling block together with a heat transfer interface material.

In addition, a conventional battery cell insertion cooling type cooling block has a structure in which a cooling fluid inlet through which cooling fluid, i.e., coolant, flows is disposed on a side surface of the cooling block so as to be directly connected to a specific slot.

In the case of the conventional battery cell bottom cooling type cooling block, a contact area with the cooling block is small in that only the bottom or top surfaces of the battery cells, which have small areas, not side surfaces of the battery cells, which have relatively large areas, are in contact with the cooling block. In the case of the conventional battery cell insertion type cooling block, because of low thermal conductivity of the battery cells, a temperature deviation between the battery cells increases. In addition, there is a limitation that the conventional cooling blocks are not able to respond to an increase in a heat value, which is attributable to high density of the battery cells and a reduction in charging time.

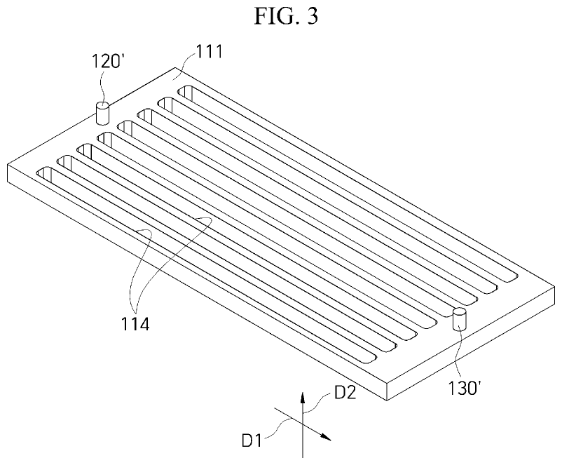

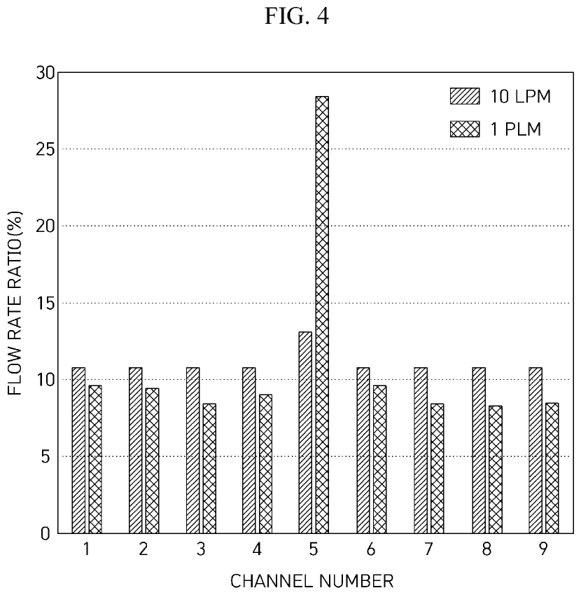

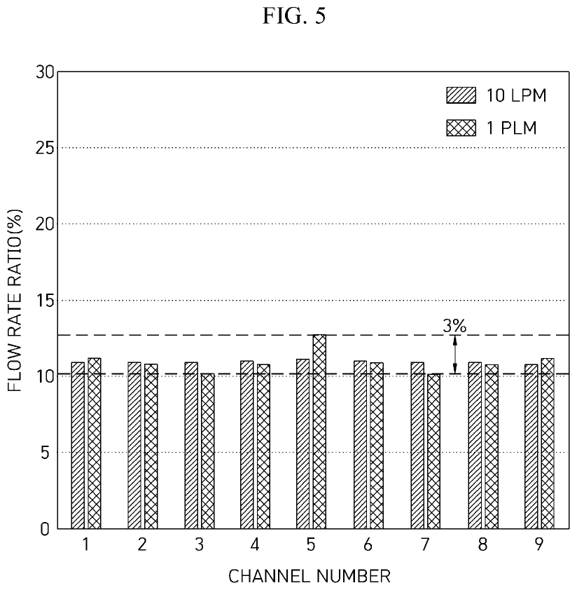

FIG. 2 is a diagram illustrating the battery cell insertion type cooling block in accordance with the first embodiment of the present disclosure, FIG. 3 is a diagram illustrating a battery cooling device 100 for an electric vehicle in accordance with the first embodiment of the present disclosure, FIG. 4 is a graph illustrating a configuration and a flow rate ratio for each channel when an inlet nipple 120 and an outlet nipple 130 are positioned on the side of a cooling block 110, and FIG. 5 is a graph illustrating a flow rate ratio for each channel in accordance with the present disclosure.

Referring to FIG. 2, the battery cooling device 100 for an electric vehicle in accordance with the first embodiment of the present disclosure may be configured to include a cooling block 110, an inlet nipple 120 provided on the cooling block 110, and an outlet nipple 130 provided at the opposite position of the inlet nipple 120 on the cooling block 110.

The cooling block 110 includes a plurality of slots into which battery cell lines each composed of a plurality of battery cells are inserted, that is, battery cell accommodating units, and a plurality of branch channels 114, which are flow passages through which cooling fluid flows along the inside in a longitudinal direction (D1), are formed.

Each of the branch channels 114 partitions the battery cell accommodating units, which are the respective slots of the cooling block 110, and each of the branch channels 114 has the same shape and cross-sectional area. Since channel widths of the branch channels 114 are formed to have the same size, the cooling fluid, i.e., coolant, through each of the branch channels 114 flows at the same flow rate.

The distance between each of the battery cell accommodating units and each of the branch channels 114 is provided to correspond to the arrangement of the plurality of battery cell lines. As an inner surface of each slot is in close contact with a side surface of each of the plurality of battery cells as much as possible, heat emitted from the plurality of battery cells may be directly transferred to the cooling block 110.

In addition, as an aluminum material with excellent heat transfer efficiency is applied to the cooling block 110, the cooling block 110 may fully absorb the heat generated from the plurality of battery cells and maximize cooling performance.

An inlet chamber 111, which is an internal space where the cooling fluid introduced through the inlet nipple 120 to be described below is accommodated, is provided at one side of the cooling block 110, and an outlet chamber 130, which is an internal space where the cooling fluid flowing through the branch channels 114 is accommodated or collected, is provided at the other side of the cooling block 110.

Referring to FIGS. 3 and 4 as another example of the first embodiment of the present disclosure, branch channels 114 may be formed along a first direction D1 in the first embodiment, and an inlet nipple 120′ and an outlet nipple 130′ may be formed along a second direction D2 intersecting, for example, orthogonal to, the first direction D1. Herein, the configuration that the branch channels 114 are formed along the first direction D1 may be defined as the configuration that a movement direction of coolant moving along the branch channels 114 is the first direction D1. In addition, the configuration that the inlet nipple 120′ and the outlet nipple 130′ are formed along the second direction D2 may be defined as the configuration that a movement direction of coolant moving along the inlet nipple 120′ and the outlet nipple 130′ is the second direction D2.

For example, the branch channels 114 may be formed along a longitudinal direction (left and right directions based on FIG. 3), that is, the first direction D1, of the cooling block 110, and the inlet nipple 120′ and the outlet nipple 130′ may be formed on a top surface (based on FIG. 3) of the cooling block 110 along a height direction (up and down directions based on FIG. 3), that is, the second direction D2, of the cooling block 110.

This is to form more uniform flow rate ratios of the coolant moving along the plurality of branch channels 114.

In other words, when the direction in which the coolant moves along the inlet nipple 120 and the outlet nipple 130 and the direction in which the coolant moves along the branch channels 114 (for example, the first direction) are the same as each other, that is, the inlet nipple 120 and the outlet nipple 130 are formed along the longitudinal direction of the cooling block 110 (refer to FIG. 2), it may be seen, as illustrated in FIG. 4, that the flow rate ratio of the coolant passing through a branch channel 114, for example, branch channel \textcircled{5}, which is the most adjacent to the inlet nipple 120′, is approximately three times higher than the flow rate ratio of the coolant passing through a branch channel 114, for example, branch channel \textcircled{9}, which is farthest from the inlet nipple 120′.

As such, when the flow rate ratio of the coolant passing through a specific flow passage among the plurality of branch channels 114 is relatively high, a temperature deviation between a plurality of battery cells, for example, battery cells accommodated in different accommodating units, is caused, which may result in a reduction in performance and efficiency of a battery module.

On the other hand, when the inlet nipple 120′ or the outlet nipple 130′ and the branch channels 114 are formed in a direction intersecting (vertical to) each other, impingement flow of the coolant introduced into the inlet chamber 111 may be caused, that is, the coolant in a uniformly mixed state inside the inlet chamber 111 may be supplied to each of the branch channels 114. Accordingly, the flow rate ratios of the coolant branching to the plurality of branch channels 114 may be formed more uniformly.

Therefore, since the cooling fluid is collected in the inlet chamber 111 and then flows in the same amount through each of the branch channels 114, the same amount of cooling fluid may flow for each branch channel 114 of each slot. Consequently, according to an embodiment of the present disclosure, it is possible to obtain advantageous effects of minimizing the temperature deviation between the plurality of battery cells 200 and suppressing performance and efficiency degradation attributable to the temperature deviation between the battery cells 200.

That is, referring to FIG. 5, when the inlet nipple 120′ or the outlet nipple 130′ and the branch channels 114 are formed in the direction intersecting (vertical to) each other, it may be seen that a flow rate ratio deviation between a branch channel 114, for example, branch channel \textcircled{5}, having a highest flow rate ratio and a branch channel 114, for example, branch channel \textcircled{7}, having a lowest flow rate ratio among the plurality of branch channels 114 is extremely low, approximately 3%.

Accordingly, in the present disclosure, as the inlet nipple 120 and the outlet nipple 130 may be disposed to be connected to top surfaces of, that is, be vertical to, the inlet chamber 111 and the outlet chamber 112, respectively, the same flow rate may be formed in all the channels and thus a flow rate imbalance may be prevented.

As such, in an embodiment of the present disclosure, since the flow rate ratio deviation for each channel is not high, the temperature deviation between the battery cells may be reduced, and the flow rate for each channel may be uniformed without a separate additional cooling device or a shape change of the branch channels 114.

Above all, according to the first embodiment of the present disclosure, there is no need to provide a separate device or change the structures and shapes of the branch channels 114 to minimize the flow rate ratio deviation of the coolant moving along the plurality of branch channels 114. The flow rate ratios of the coolant moving along the branch channels 114 may be formed uniformly simply by changing the positions of the inlet nipple 120′ and the outlet nipple 130′, that is, disposing the inlet nipple 120′ and the outlet nipple 130′ vertically to the branch channels 114.

Meanwhile, it is described as an example in the first embodiment of the present disclosure that the inlet nipple 120′ and the outlet nipple 130′ are positioned on the same line, for example, on a center line passing through center parts of the inlet chamber 111 and the outlet chamber 112, but according to another embodiment of the present disclosure, it is also possible to configure the inlet nipple 120′ and the outlet nipple 130′ that are disposed on different lines.

The positions of the inlet nipple 120′ and the outlet nipple 130′ may be variously changed depending on required conditions and design specifications, and the present disclosure is not restricted or limited by a relative position of the outlet nipple 130′ with respect to the inlet nipple 120′.

Meanwhile, the height of the cooling block 110 may be formed to be greater than the height of each of the battery cells. Accordingly, the cooling block 110 may cover all the side surfaces of the battery cells, and further increase the cooling performance.

In an embodiment of the present disclosure, as a heat transfer interface material is provided on the inner surface of the slot of the cooling block 110, the heat transfer interface material is in close contact with the side surface of each of the battery cells, which makes it possible to further improve the cooling performance.

In the case of the battery cooling device for an electric vehicle according to another embodiment of the present disclosure, a plurality of inlet nipples 120 and a plurality of outlet nipples 130 may be provided on the cooling block, and each of the inlet nipples 120 and each of the outlet nipples 130 may be disposed side by side in a line.

Particularly, the other inlet nipples except for a specific inlet nipple, for example, an inlet nipple positioned in the middle of the plurality of inlet nipples 120, may be kept closed by an inlet nipple cover. Accordingly, the cooling fluid may be introduced into the inlet chamber through the specific inlet nipple.

In addition, similarly, the other outlet nipples except for a specific outlet nipple, for example, an outlet nipple positioned in the middle of the plurality of outlet nipples, may be kept closed by an outlet nipple cover. Accordingly, the cooling fluid may be discharged from the cooling block to the outside through the specific outlet nipple.

In this case, as the inlet nipple cover and the outlet nipple cover are fixed to the inlet nipple and the outlet nipple, respectively, through bolt coupling, the inlet nipple cover and the outlet nipple cover may be opened or closed through rotation in a clockwise or counterclockwise direction.

Furthermore, in another embodiment of the present disclosure, the inlet nipple and the outlet nipple may be positioned to face top and bottom sides of the inlet chamber and the outlet chamber of the cooling block in opposite directions, respectively.

For example, in an embodiment of the present disclosure, the inlet nipple may be positioned on the top surface of the inlet chamber at one end of the cooling block, and in this case, the outlet nipple may be positioned on the bottom surface of the outlet chamber at the other end of the cooling block.

A process of determining an optimal position of the inlet nipple 120 of the cooling block 110 of the present disclosure is as follows.

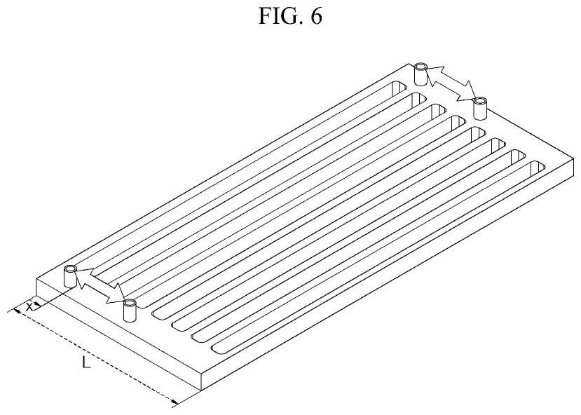

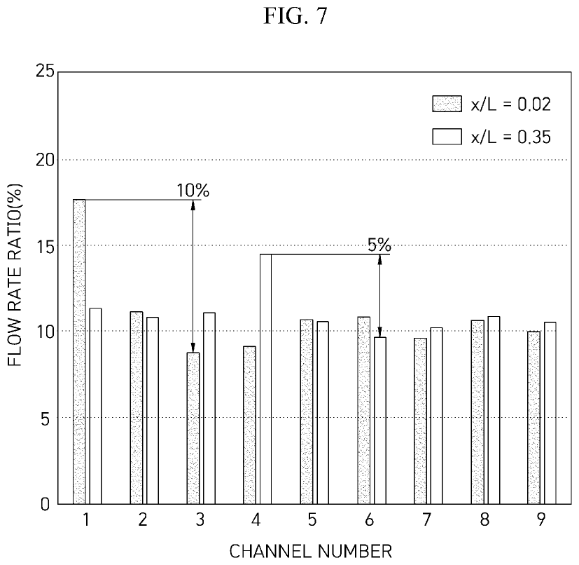

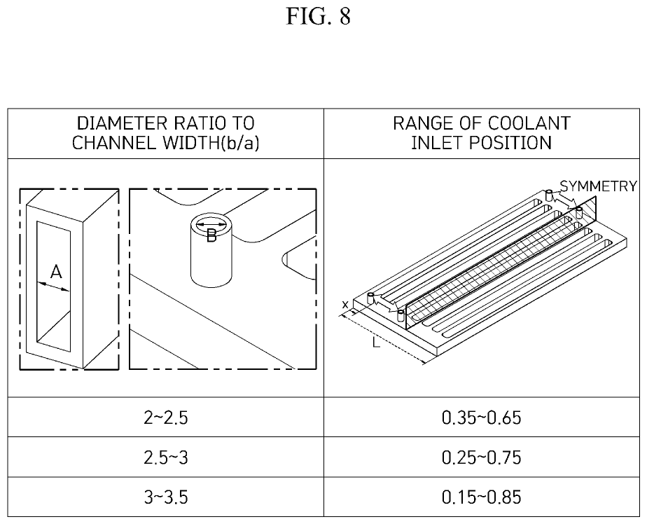

FIG. 6 is a schematic diagram illustrating a position change of the inlet nipple 120 for determining optimal positions of the inlet nipple 120 and the outlet nipple 130 positioned on the cooling block 110, FIG. 7 is a graph illustrating the flow rate ratio for each channel according to the position change of the inlet nipple 120, and FIG. 8 is a diagram illustrating a diameter ratio compared to a channel width of the cooling block 110 and a position range of the inlet nipple 120 compared to a width of the cooling block 110.

Referring to FIGS. 6 to 8, in order to secure the degree of freedom of the inlet nipple 120 for introduction of the coolant or cooling fluid in the present disclosure, it is possible to identify the flow rate ratio for each channel according to the ratio between an entire width “L” of the cooling block 110 and a position “x” of the inlet nipple 120 from the center of an inlet so that flow rate equalization of each channel of the cooling block 110 may be maintained.

The flow rate deviation of each channel increases as the diameter of the inlet nipple 120 becomes smaller and the total flow rate becomes larger.

According to the present disclosure, given that the shape of the cooling block 110 is symmetrical with respect to a center part thereof, a position where the flow rate deviation of each channel can be equalized within 5% may be determined as an optimal disposition position of the inlet nipple 120, and in this case, the distance of the inlet nipple 120 compared to the entire width “L” of the cooling block 110 may be 0.35 to 0.65. In addition, as illustrated in FIGS. 7 and 8, when the diameter ratio of the inlet nipple 120 compared to the channel width is 2 or higher, the inlet nipple 120 according to the present disclosure may be determined to have an optimal flow distribution ratio, and the determined optimal flow distribution ratio may be reflected into the disposition position of the inlet nipple 120.

### Second Embodiment

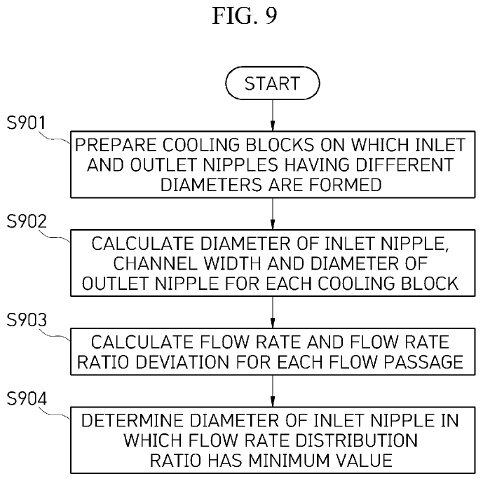

FIG. 9 is a flowchart sequentially illustrating a process of determining a coolant inlet/outlet diameter ratio of a battery cooling device for an electric vehicle in accordance with a second embodiment of the present disclosure.

Referring to FIG. 9, in the second embodiment of the present disclosure, a plurality of cooling blocks on which an inlet nipple and an outlet nipple having different diameters are formed are prepared in step S901. The inlet and outlet nipples of each of the cooling blocks are positioned in the middle of an inlet chamber and an outlet chamber, respectively.

In this case, the diameter of the inlet nipple may be formed to be equal to, 1.5 times larger or 2 times larger than the width of a corresponding channel compared to the width of the channel in branch channels 114 of a corresponding cooling block.

That is, according to the second embodiment of the present disclosure, three cooling blocks on which the inlet and outlet nipples having different diameters are formed may be prepared.

Subsequently, in the second embodiment of the present disclosure, the diameter of the inlet nipple for each cooling block, the channel width of the channel formed inside each branch channel 114, and the diameter of the outlet nipple are calculated in step S902. A flow rate of cooling fluid flowing through each of a plurality of branch channels 114 for each cooling block is calculated, and then a flow rate ratio deviation for each branch channel 114 compared to the diameter of the inlet nipple of the corresponding cooling block is calculated in step S903.

More specifically, when the channel width is equal to the diameter of the inlet nipple, the flow rate of a channel positioned in the middle of a plurality of channels increases, and accordingly, a flow distribution ratio for each channel may vary significantly.

The reason is that, due to structural characteristics of cooling blocks, the pressure drop generated as a flow direction of a cooling fluid is bent by 90 degrees in a direction parallel to each channel after the cooling fluid is collected in an inlet chamber is large, and thus an effect of the pressure drop of the cooling fluid distributed to a corresponding channel is reduced in a channel which is relatively far from the inlet nipple.

Accordingly, in the second embodiment of the present disclosure, the flow rate ratio deviation for each branch channel 114 compared to the diameter of the inlet nipple is calculated for a cooling block in which the channel width is equal to the diameter of the inlet nipple, a cooling block in which the diameter of the inlet nipple is 1.5 times larger than the channel width, and a cooling block in which the diameter of the inlet nipple is 2 times larger than the channel width, and then the diameters of the inlet and outlet nipples in which a flow distribution ratio for each channel of each cooling block has the minimum value are determined in step S904.

Experimental results related to the process of determining the coolant inlet/outlet diameter ratio are represented as a graph, which is to be described below.

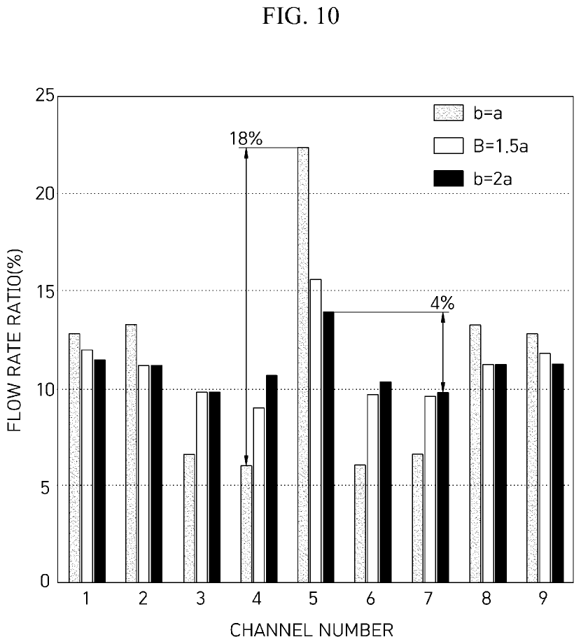

FIG. 10 is a graph illustrating a flow rate ratio for each channel according to a diameter change of an inlet nipple.

Referring to FIG. 10, it may be seen that as a diameter “b” of the inlet nipple compared to a channel width “a” of a cooling block increases, the flow rate ratio of cooling fluid introduced into each channel becomes uniform. This is because as the diameter of the inlet nipple increases, the ratio of pressure drop generated from an inlet and an outlet to the entire cooling block decreases, and thus the pressure drop due to flow resistance of each channel acts predominantly.

Consequently, it was confirmed that the flow rate ratio deviation for each channel was less than approximately 5% in the cooling block in which the diameter of the inlet nipple was twice the channel width. Therefore, in the present disclosure, considering the channel width of the cooling block on the basis of the confirmed result, the diameters of the inlet and outlet nipples of the cooling block are determined as twice the channel width. In this case, the diameters of the inlet and outlet nipples are not limited to twice the channel width, and a larger multiple may also be applied thereto.

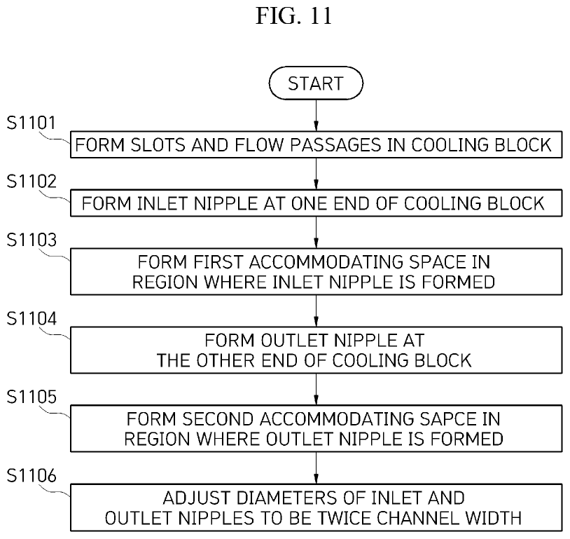

FIG. 11 is a diagram sequentially illustrating a manufacturing method of the battery cooling device for an electric vehicle in accordance with the second embodiment of the present disclosure.

Referring to FIG. 11, a cooling block 110 is prepared first. In this case, a plurality of slots for inserting battery cell lines composed of a plurality of battery cells are formed in the cooling block 110, and particularly, a plurality of branch channels 114 through which cooling fluid flows along the inside in a longitudinal direction are formed in step S1101.

Next, an inlet nipple 120 for introducing the cooling fluid is formed upward from one end of the cooling block 110 in step S1102. In this case, the diameter of the inlet nipple 120 may be formed to be twice the channel width of the branch channel 114 formed in each slot.

Next, an inlet chamber for accommodating the cooling fluid introduced through the inlet nipple 120 is formed at the inner side of the cooling block 110, particularly, on the inner side of a region where the inlet nipple 120 is formed, in step S1103, and an outlet nipple 130 for discharging the cooling fluid is formed upward from the other (opposite) end of the cooling block 110 in step S1104. In this case, the diameter of the outlet nipple 130 may be formed to be twice the channel width of the branch channel 114 formed in each slot.

Next, an outlet chamber for collecting and accommodating the cooling fluid flowing through the plurality of branch channel 114 is formed at the inter side of the cooling block 110, particularly, at the inner side of a region where the outlet nipple 130 is formed, in step S1105.

Next, the diameters of the inlet and outlet nipples 120 and 130 formed earlier are adjusted to be twice the channel width of the branch channel 114, in step S1106.

Through this process, the present disclosure may have the advantage of minimizing the distribution ratio deviation according to the flow rate change.

### Third Embodiment

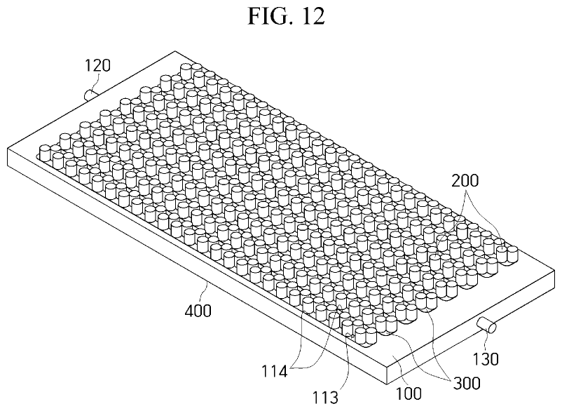

Referring to FIGS. 12 to 18, a battery module 10 according to a third embodiment of the present disclosure includes battery cells 200, battery cell accommodating units in which one end parts of the battery cells 200 are accommodated, and a cooling block 100 configured to cool lateral circumferences of the battery cells 200 corresponding to the battery cell accommodating units 113.

For reference, the battery module 10 according to the third embodiment of the present disclosure may be mounted on various objects depending on required conditions and design specifications, and the present disclosure is not restricted or limited by types and structures of the objects.

Hereinafter, an example in which the battery module 10 according to the third embodiment of the present disclosure is applied to an electric vehicle or a hybrid vehicle will be described.

Each of the battery cells 200 refers to a minimum unit of a secondary battery composed of one or more electrochemical cells capable of being charged and discharged. Various battery cells may be used as the battery cells 200 depending on required conditions and design specifications, and the present disclosure is not restricted or limited by types and characteristics of the battery cells 200. For example, the battery cells 200 may be provided in a structure in which an electrode solution, a positive electrode material and a negative electrode material are sealed inside a case or a pouch, and the present disclosure is not restricted or limited by structures and shapes of the battery cells 200.

Hereinafter, an example in which the battery cells 200 are formed in cylindrical shapes will be described. According to another embodiment of the present disclosure, it is also possible to form the battery cells in prismatic shapes.

The cooling block 110 is provided to cool the lateral circumferences of the battery cells 200.

More specifically, the cooling block 110 may include the battery cell accommodating units in which one end parts of the battery cells 200 are accommodated, and the lateral circumferences of the battery cells 200 corresponding to the battery cell accommodating units 113 may be cooled by the cooling block 110.

In the second embodiment of the present disclosure, the one end parts of the battery cells 200 may be accommodated in the battery cell accommodating units 113 of the cooling block 110, and the lateral circumferences of the battery cells 200 corresponding to the battery cell accommodating units 113 may be entirely cooled. Therefore, it is possible to obtain an advantageous effect of improving cooling performance, stability, and reliability of the battery cells 200.

Above all, in the second embodiment of the present disclosure, a mutual heat exchange area between the battery cells 200 and the cooling block 110 may be secured along the lateral circumferences of the battery cells 200, not the outermost end parts, i.e., bottom or top surfaces of the battery cells 200. Therefore, it is possible to obtain advantageous effects of improving cooling efficiency of the battery cells 200 and minimizing a temperature deviation for each section of the battery cells 200.

The battery cell accommodating units 113 may be provided in various structures and shapes capable of partially accommodating the one end parts of the battery cells 200, and the present disclosure is not restricted or limited by the structures and shapes of the battery cell accommodating units 113.

Preferably, each of the battery cell accommodating units 113 may be provided to have a more expanded size (cross-sectional area) than each of the battery cells 200. In addition, a plurality of battery cells 200 may be accommodated in the battery cell accommodating units 113.

In the second embodiment of the present disclosure described above, it is described as an example that each of the battery cell accommodating units 113 has a more expanded size than each of the battery cells 200, and the plurality of battery cells 200 are accommodated in the battery cell accommodating units 113, but according to another embodiment of the present disclosure, it is also possible to provide an accommodating unit having a structure and a size corresponding to a battery cell and accommodate only one battery cell in a single accommodating unit.

The cooling block 110 may be provided in various structures capable of cooling the lateral circumferences of the battery cells 200, and the present disclosure is not restricted or limited by a cooling method of the cooling block 110.

For example, the cooling block 110 may be provided with branch channels 114, which are coolant movement passages through which coolant moves, and be configured to cool side surfaces of the battery cells 200 in a water cooling manner. The branch channels 114 may be provided in various structures depending on required conditions and design specifications.

According to a preferred embodiment of the present disclosure, the branch channels 114 may include an inlet nipple 120 which is provided on the cooling block 110 and through which the coolant is introduced, an inlet chamber 111 provided on the cooling block 110 and configured to communicate with the inlet nipple 120, a plurality of branch channels 114, which are coolant flow passages individually connected to the inlet chamber 111, an outlet chamber 112 provided on the cooling block 110 and configured to communicate with the plurality of branch channels 114, and an outlet nipple 130 which is provided on the cooling block 110 and through which the coolant is discharged to the outside.

The coolant introduced through the inlet nipple 120 may be supplied to the plurality of branch channels 114 after passing through the inlet chamber 111. The coolant passing through the branch channels 114 may be discharged to the outside through the outlet nipple 130 after passing through the outlet chamber 112.

As such, in the second embodiment of the present disclosure, the coolant introduced into the inlet nipple 120 may pass through the inlet chamber 111 (after filled with the inlet chamber), and then branch to the plurality of branch channels 114. Therefore, it is possible to obtain an advantageous effect of forming a relatively uniform supply flow rate of the coolant supplied to each of the branch channels 114.

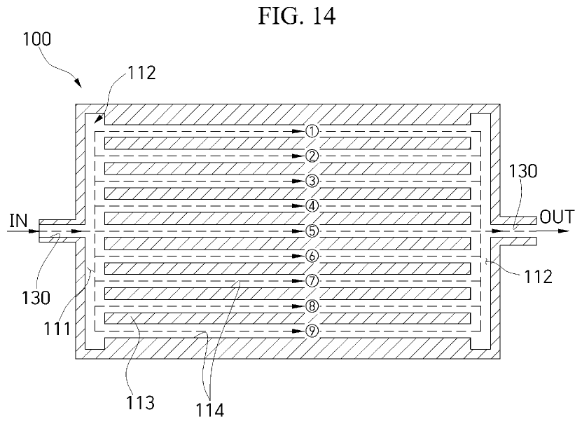

The inlet nipple 120 may be provided at one end (i.e., a left end based on FIG. 14) of the cooling block 110 and communicate with the inlet chamber 111, and the coolant may be introduced through the inlet nipple 120.

The outlet nipple 130 may be provided at the other end (i.e., a right end based on FIG. 14) of the cooling block 110 and communicate with the outlet chamber 112, and the coolant may be discharged through the outlet nipple 130.

The plurality of branch channels 114 are provided to be individually connected to (communicate with) the inlet chamber 111 and the outlet chamber 112.

More specifically, one end of the branch channels 114 is connected to (communicate with) the inlet chamber 111, and the other end thereof is connected to (communicate with) the outlet chamber 112.

The number and spacing of the branch channels 114 may be variously changed depending on required conditions and design specifications, and the present disclosure is not restricted or limited by the number and spacing of the branch channels 114.

Hereinafter, an example in which the cooling block 110 includes nine branch channels 114 having roughly linear shapes and disposed in parallel to one another will be described. According to another embodiment of the present disclosure, the cooling block may include 8 or less branch channels, or include 10 or more branch channels.

Preferably, the branch channels 114 may be defined along the space between the battery cell accommodating units 113 adjacent to each other.

According to a preferred embodiment of the present disclosure, the battery module 10 may further include heat exchange members 300 interposed between the battery cells 200 and the battery cell accommodating units 113 so as to mutually exchange heat with the battery cells 200 and the cooling block 110.

Various materials (i.e., metal or non-metal) capable of mutually exchanging (or transferring) heat with (or to) the battery cells 200 and the cooling block 110 may be used as the heat exchange members 300, and the present disclosure is not restricted or limited by materials and characteristics of the heat exchange members 300.

For example, the heat exchange members 300 may be formed to have shapes corresponding to the battery cell accommodating units 113, and be provided to completely surround the lateral circumferences of the plurality of battery cells 200.

For reference, the heat exchange members 300 may be accommodated in the battery cell accommodating units 113 after being manufactured to surround the lateral circumferences of the plurality of battery cells 200. Alternatively, it is also possible to form the heat exchange members 300 by filling the battery cell accommodating units 113 with heat exchange materials and hardening the heat exchange materials in a state in which the battery cells 200 are disposed in the battery cell accommodating units 113.

In this way, as the heat exchange members 300 are interposed between the battery cells 200 and the battery cell accommodating units 113, the battery cells 200 and the cooling block 110 may be in close contact with each other through the heat exchange members 300. Accordingly, it is possible to obtain an advantageous effect of further improving mutual heat exchange (heat transfer) efficiency of the battery cells 200 and the cooling block 110.

In addition, according to a preferred embodiment of the present disclosure, the battery module 10 may include a support member 400 which is provided on one surface of the cooling block 110 and supports the battery cells 200 with respect to the cooling block 110.

The support member 400 may be provided in various structures capable of supporting the battery cells 200 with respect to the cooling block 110.

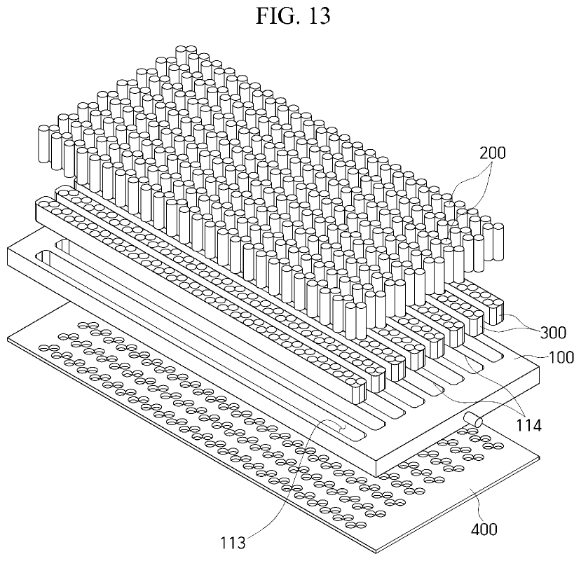

For example, the support member 400, which is provided to have a thin plate shape, may be in close contact with a bottom surface of the cooling block 110 (refer to FIG. 13), and lower ends of the battery cells 200 may be supported on a top surface of the support member 400.

Preferably, since the support member 400 is in direct contact with the battery cells 200, the support member 400 may be formed of a material having electrical insulation properties.

As the battery cells 200 are supported by the support member 400, it is possible to obtain an advantageous effect of suppressing movement and separation of the battery cells 200 with respect to the cooling block 110, and more stably maintaining disposition states of the battery cells 200.

According to the third embodiment of the present disclosure, as illustrated in FIG. 3, the branch channels 114 may be formed along the first direction D1 as in the first embodiment, and the inlet nipple 120′ and the outlet nipple 130′ may be formed along the second direction D2 intersecting, for example, orthogonal to, the first direction D1.

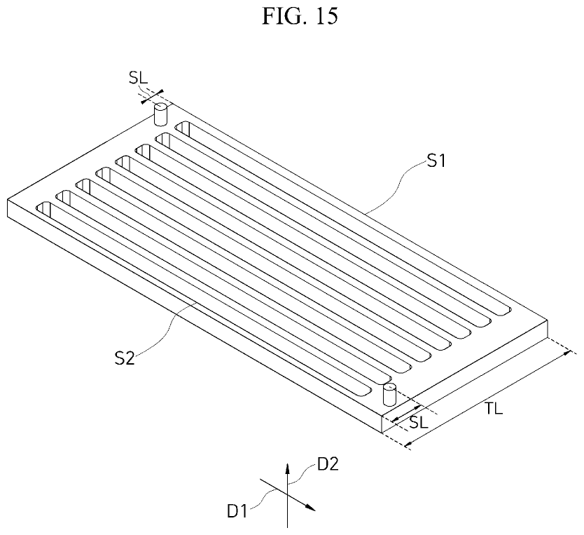

For example, referring to FIG. 15, the inlet nipple 120′ may be provided to be spaced apart from one side S1 of the cooling block 110 at a predetermined reference interval SL along a longitudinal direction of the inlet chamber 111, and the outlet nipple 130′ may be provided to be spaced apart from another side S2 of the cooling block 110, which faces the one side S1, at the reference interval SL.

In other words, the inlet chamber 111 (or the outlet chamber) may be disposed 180 degrees rotationally symmetrical to the outlet chamber 112 (or the inlet chamber) with respect to a central part of the cooling block 110.

Preferably, the reference interval SL may be defined as a length smaller than ½ of a total length TL of the inlet chamber 111 (the outlet chamber). In some cases, the reference interval SL may be defined as a length greater than ½ of the total length TL of the inlet chamber 111.

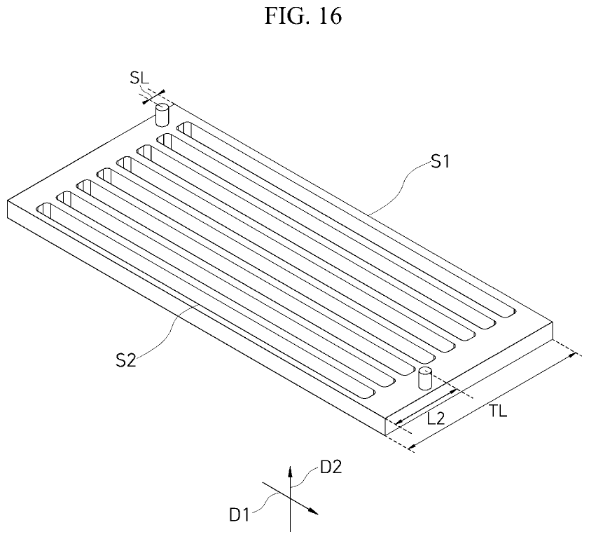

For another example, referring to FIG. 16, the inlet nipple 120′ may be provided to be spaced apart from one side S1 of the cooling block 110 at a first interval L1, and the outlet nipple 130′ may be provided to be spaced apart from another side S2 of the cooling block 110, which faces the one side S1, at a second interval L2 different from the first interval L1.

In other words, the inlet nipple 120′ (or the outlet nipple) may be asymmetrically disposed with the outlet nipple 130′ (or the inlet nipple) with respect to a central part of the cooling block 110.

A difference between the first interval L1 and the second interval L2 may be variously changed depending on required conditions and design specifications, and the present disclosure is not restricted or limited by the difference between the first interval L1 and the second interval L2.

However, the symmetrical disposition of the inlet nipple 120′ and the outlet nipple 130′ (refer to FIG. 16) may more uniformly form the flow rate ratio of the coolant moving along each of the branch channels 114 than the asymmetrical disposition of the inlet nipple 120′ and the outlet nipple 130′ (refer to FIG. 16). Therefore, it is preferable to dispose the inlet nipple 120′ (or the outlet nipple) 180 degrees rotationally symmetrically with the outlet nipple 130′ (or the inlet nipple) with respect to the central part of the cooling block 110 (refer to FIG. 8).

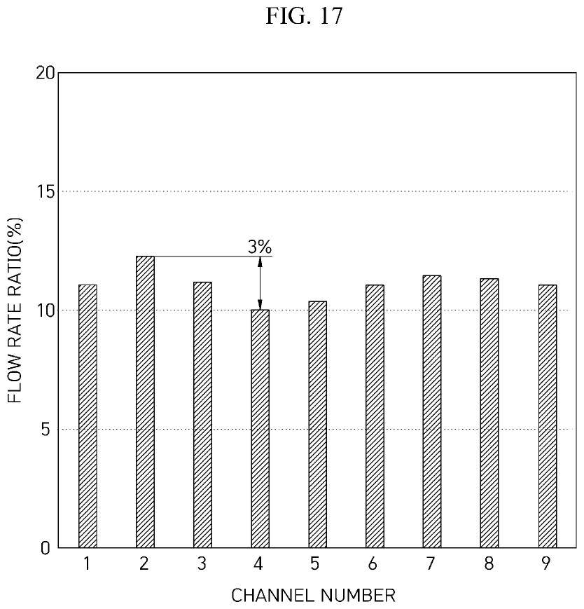

That is, referring to FIG. 17, when the inlet nipple 120′ and the outlet nipple 130′ are symmetrically disposed (refer to FIG. 16), it may be seen that the flow rate ratio deviation between a branch channel 114, for example, branch channel \textcircled{2}, with the highest flow rate ratio and a branch channel 114, for example, branch channel \textcircled{4}, with the lowest flow rate ratio among the plurality of branch channels 114 is quite low, approximately 3%.

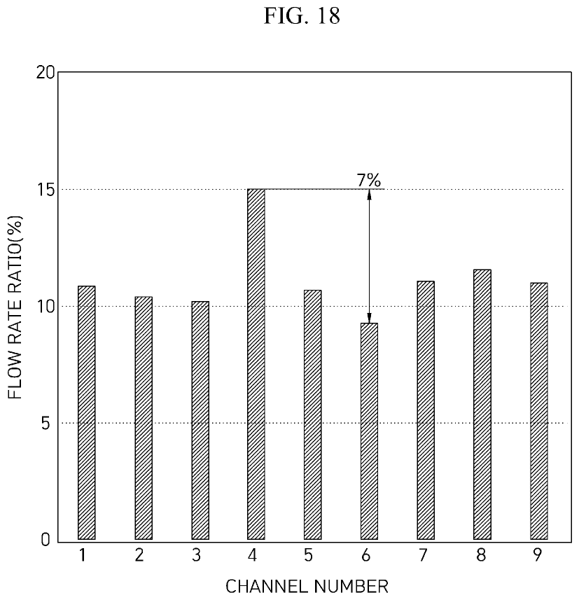

On the other hand, referring to FIG. 18, when the inlet nipple 120′ and the outlet nipple 130′ are asymmetrically disposed (refer to FIG. 16), it may be seen that the flow rate ratio deviation between a branch channel 114, for example, branch channel \textcircled{4}, with the highest flow rate ratio and a branch channel 114, for example, branch channel \textcircled{6}, with the lowest flow rate ratio among the plurality of branch channels 114 is relatively high, approximately 7%.

Meanwhile, a cross-sectional area of the inlet nipple 120′ (or the outlet nipple) and a cross-sectional area of the branch channels 114 may be variously changed depending on required conditions and design specifications, and the present disclosure is not restricted or limited by the cross-sectional area of the inlet nipple 120′ (or the outlet nipple) and the cross-sectional area of the branch channels 114.

According to a preferred embodiment of the present disclosure, the inlet nipple 120′ may be defined to have a first cross-sectional area, and the branch channels 114 may be defined to have a second cross-sectional area that is at least twice larger than the first cross-sectional area.

This is due to the fact that when the cross-sectional area, i.e., the second cross-sectional area, of the branch channels 114 is smaller than twice the cross-sectional area, i.e., the first cross-sectional area, of the inlet nipple 120′, the flow rate ratio deviation between the branch channel 114 with the highest flow rate ratio and the branch channel 114 with the lowest flow rate ratio among the plurality of branch channels 114 exceeds 5%, whereas the cross-sectional area, i.e., the second cross-sectional area, of the branch channels 114 is at least twice larger than the cross-sectional area, i.e., the first cross-sectional area, of the inlet nipple 120′, the flow rate ratio deviation between the branch channel 114 with the highest flow rate ratio and the branch channel 114 with the lowest flow rate ratio among the plurality of branch channels 114 is 5% or less.

For example, when a cross-sectional area ratio of the branch channels 114 and the inlet nipple 120′ (i.e., the cross-sectional area of the inlet nipple 120′/the cross-sectional area of the branch channels 114) is 2 to 3 and a value of the reference interval SL/the total length TX of the inlet chamber 111 is 0.15 to 0.5, the flow rate ratio deviation (i.e., a maximum flow rate ratio vs. a minimum flow rate ratio) between the plurality of branch channels 114 may satisfy 5% or less.

For another example, when the cross-sectional area ratio of the branch channels 114 and the inlet nipple 120′ (i.e., the cross-sectional area of the inlet nipple 120′/the cross-sectional area of the branch channels 114) is 3 to 4 and the value of the reference interval SL/the total length TX of the inlet chamber 111 is 0.1 to 0.5, the flow rate ratio deviation (i.e., the maximum flow rate ratio vs. the minimum flow rate ratio) between the plurality of branch channels 114 may satisfy 5% or less.

For still another example, when the cross-sectional area ratio of the branch channels 114 and the inlet nipple 120′ (i.e., the cross-sectional area of the inlet nipple 120′/the cross-sectional area of the branch channels 114) is 4 or more and the value of the reference interval SL/the total length TX of the inlet chamber 111 is 0 to 0.5, the flow rate ratio deviation (i.e., the maximum flow rate ratio vs. the minimum flow rate ratio) between the plurality of branch channels 114 may satisfy 5% or less.

Therefore, it is preferable that the inlet nipple 120′ is formed to have the first cross-sectional area, and the branch channels 114 is formed to have the second cross-sectional area that is at least twice larger than the first cross-sectional area.

In order to perform this operation, the heat exchange members 300 may be composed of a thermally conductive material. The thermally conductive material may include a metal material such as aluminum having excellent thermal conductivity, a thermally conductive polymer composition, and a carbon composite such as graphene, carbon nanotubes and graphite.

In an embodiment, remaining spaces in which the battery cells 200 are not disposed inside the battery cell accommodating units 113 may be filled with the heat exchange members 300. Herein, all the remaining spaces of the battery cell accommodating units 113 may be filled with the heat exchange members 300 so that an empty space is not formed between the cooling block 110 and the battery cells 200 in order to increase heat transfer efficiency.

In order to perform this operation, the support member 400 may include a plurality of openings into which the battery cells 200 may be inserted, and be positioned on a lower part of the cooling block 110. Herein, the battery cells 200 may be inserted into the openings formed in the support member 400 and be fitted-coupled into the openings.

In one embodiment, the support member 400 may be composed of an electrically insulating material to prevent short circuits of the battery cells 200. The electrically insulating material may include a polymer material such as rubber and plastic.

In one embodiment, each component of the battery insertion type cooling system described above may be assembled through a fitting-coupling method without connecting members such as screws and bolts, and have excellent manufacturability and assembling properties.

Each step included in the method described above may be implemented as a software module, a hardware module, or a combination thereof, which is executed by a computing device.

Also, an element for performing each step may be respectively implemented as first to two operational logics of a processor.

The software module may be provided in RAM, flash memory, ROM, erasable programmable read only memory (EPROM), electrical erasable programmable read only memory (EEPROM), a register, a hard disk, an attachable/detachable disk, or a storage medium (i.e., a memory and/or a storage) such as CD-ROM.

An exemplary storage medium may be coupled to the processor, and the processor may read out information from the storage medium and may write information in the storage medium. In other embodiments, the storage medium may be provided as one body with the processor.

The processor and the storage medium may be provided in application specific integrated circuit (ASIC). The ASIC may be provided in a user terminal. In other embodiments, the processor and the storage medium may be provided as individual components in a user terminal.

Exemplary methods according to embodiments may be expressed as a series of operation for clarity of description, but such a step does not limit a sequence in which operations are performed. Depending on the case, steps may be performed simultaneously or in different sequences.

In order to implement a method according to embodiments, a disclosed step may additionally include another step, include steps other than some steps, or include another additional step other than some steps.

Various embodiments of the present disclosure do not list all available combinations but are for describing a representative aspect of the present disclosure, and descriptions of various embodiments may be applied independently or may be applied through a combination of two or more.

Moreover, various embodiments of the present disclosure may be implemented with hardware, firmware, software, or a combination thereof. In a case where various embodiments of the present disclosure are implemented with hardware, various embodiments of the present disclosure may be implemented with one or more application specific integrated circuits (ASICs), digital signal processors (DSPs), digital signal processing devices (DSPDs), programmable logic devices (PLDs), field programmable gate arrays (FPGAs), general processors, controllers, microcontrollers, or microprocessors.

The scope of the present disclosure may include software or machine-executable instructions (for example, an operation system (OS), applications, firmware, programs, etc.), which enable operations of a method according to various embodiments to be executed in a device or a computer, and a non-transitory computer-readable medium capable of being executed in a device or a computer each storing the software or the instructions.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

While the present disclosure has been described with reference to specific embodiments, those skilled in the art will be able to understand that the present disclosure may be variously changed and modified without departing from the spirit and scope of the present disclosure as defined in the following claims.

What is claimed is:

1. A battery cooling device for an electric vehicle, comprising:
a cooling block comprising accommodating units, each accommodating unit being configured to accommodate an end part of one or more battery cells, the cooling block being configured to cool lateral circumferences of the battery cells accommodated in the accommodating units,
wherein the cooling block comprises:
an inlet nipple configured to introduce coolant into the cooling block;
an inlet chamber configured to communicate with the inlet nipple;
branch channels individually connected to the inlet chamber;
an outlet chamber configured to communicate with each of the branch channels; and
an outlet nipple configured to discharge the coolant to the outside.

2. The battery cooling device of claim 1, wherein the cooling block is composed of a thermally conductive material.

3. The battery cooling device of claim 1, wherein the branch channels are disposed along a first direction, and the inlet and outlet nipples are disposed along a second direction intersecting the first direction.

4. The battery cooling device of claim 1, wherein the accommodating units are slots and a heat transfer interface material is disposed on an inner surface of each of the slots, and the heat transfer interface material is in close contact with a side surface of each of the battery cells.

5. The battery cooling device of claim 1, wherein the inlet nipple includes a plurality of inlet nipples, and the plurality of inlet nipples are disposed upward from a first end of the cooling block, and the cooling block comprises an inlet nipple cover configured to close all of the inlet nipples except for one specific inlet nipple.

6. The battery cooling device of claim 5, wherein the outlet nipple includes a plurality of outlet nipples disposed at a second end of the cooling block, and the cooling block comprises an outlet nipple cover configured to close all of the outlet nipples except for one specific outlet nipple.

7. The battery cooling device of claim 6, wherein the inlet nipple cover is configured to be opened or closed through bolt coupling from each of the inlet nipples.

8. The battery cooling device of claim 7, wherein the outlet nipple cover is configured to be opened or closed through bolt coupling from each of the outlet nipples.

9. A method of determining a coolant inlet/outlet diameter ratio of a battery cooling device for an electric vehicle, comprising:
preparing a plurality of cooling blocks, each of the cooling blocks including an inlet nipple and an outlet nipple having different diameters;
for each cooling block, calculating a diameter of the inlet nipple, channel widths of channels formed in a plurality of flow passages, and a diameter of the outlet nipple;
for each cooling block, calculating a flow rate of cooling fluid flowing through each of the plurality of flow passages, and calculating a flow rate ratio deviation for each flow passage compared to the diameter of the inlet nipple; and
for each cooling block, determining the diameters of the inlet and outlet nipples based on the calculated flow rate ratio deviation for each flow passage compared to the diameter of the inlet nipple.

10. The method of claim 9, wherein preparing the plurality of cooling blocks includes preparing a cooling block in which a channel width of a flow passage of each cooling block is equal to the diameter of the inlet nipple, a cooling block in which the diameter of the inlet nipple is one-and-a-half times larger than the channel width of the flow passage of each cooling block, and a cooling block in which the diameter of the inlet nipple is two times larger than the channel width of the flow passage of each cooling block.

11. A battery module comprising:
battery cells; and
a cooling block comprising accommodating units, each accommodating unit being configured to accommodate an end part of one or more of the battery cells, the cooling block being configured to cool lateral circumferences of the battery cells accommodated in the accommodating units,
wherein the cooling block comprises:
an inlet nipple configured to introduce coolant into the cooling block;
an inlet chamber configured to communicate with the inlet nipple;
branch channels individually connected to the inlet chamber;
an outlet chamber configured to communicate with each of the branch channels; and
an outlet nipple configured to discharge the coolant to the outside.

12. The battery module of claim 11, wherein the branch channels are disposed along a first direction, and the inlet and outlet nipples are disposed along a second direction intersecting the first direction.

13. The battery module of claim 12, wherein the inlet nipple is spaced apart from a first side of the cooling block at a reference interval along a longitudinal direction of the inlet chamber, and the outlet nipple is spaced apart from a second side of the cooling block, which faces the first side of the cooling block, at the reference interval.

14. The battery module of claim 12, wherein the inlet nipple is spaced apart from a first side of the cooling block at a first interval, and the outlet nipple is spaced apart from a second side of the cooling block, which faces the first side of the cooling block, at a second interval different from the first interval.

15. The battery module of claim 11, further comprising heat exchange members interposed between the battery cells and the accommodating units and configured to mutually exchange heat with the battery cells and the cooling block.
